(19) United States
(12) Patent Application Publication
(10) Pub. No.: US 2019/0073970 A1
(43) Pub. Date: Mar. 7, 2019

(54) DRIVING METHOD FOR LIQUID CRYSTAL DISPLAY PANEL, LIQUID CRYSTAL DISPLAY PANEL AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Xinghong LIU, Beijing (CN); Shuai HOU, Beijing (CN)

(21) Appl. No.: 16/081,475

(22) PCT Filed: Jan. 11, 2018
(86) PCT No.: PCT/CN2018/072206

§ 371 Date: Aug. 31, 2018

(30) Foreign Application Priority Data
Jan. 16, 2017 (CN) 201710030105.5

(51) Int. Cl. G09G 3/36

(52) U.S. Cl. CPC G09G 3/3614; G09G 2310/0264; G09G 2330/021; G09G 3/3648

(57) ABSTRACT

A source driving method for a liquid crystal display panel, a liquid crystal display panel, and a display device. In the source driving method, only the source driving signals input to one of two adjacent groups of sub-pixel columns are polarity inverted for each frame with respect to a previous frame, while source driving signals having the same polarity as those for the previous frame are input to the other group of sub-pixel columns. During display time for an adjacent next frame, polarity inversion is interchanged between the source driving signals input to the two adjacent groups of sub-pixel columns are interchanged.

### CROSS REFERENCE TO RELATED APPLICATIONS

The present application is the U.S. national phase entry of PCT/CN2018/072206, with an international filing date of Jan. 11, 2018, which claims the priority to Chinese Patent Application No. 201710030105.5, filed on Jan. 16, 2017, the entire disclosures of which are incorporated herein by reference.

### TECHNICAL FIELD

The present disclosure relates to the field of display technologies, and especially to a driving method for a liquid crystal display panel, a liquid crystal display panel and a display device.

### BACKGROUND

With the popularization of portable display devices such as notebook computers and mobile phones, the power storage capacity of display products has increasingly received attention from the consumers, and thus increasingly higher requirements have been posed on the power consumption of the display products. Currently, main ways to reduce the power consumption of a display product include reducing the power consumption of the driver chip and improving the efficiency of power conversion.

In a display product, the source driver chip mainly functions to convert a digital signal (6-bit or 8-bit) sent by a clock controller into a corresponding grayscale voltage, and to charge and discharge the pixel capacitance in each of the pixel units to which the gate line being scanned corresponds at the time of scanning the gate lines progressively.

There is still a need in the art to further reduce the power consumption of the display product.

### SUMMARY

According to an exemplary embodiment of the present disclosure, there is provided a source driving method for a liquid crystal display panel, comprising: during display time for a frame, inputting to one of two adjacent groups of sub-pixel columns source driving signals having an opposite polarity to source driving signals for a previous frame, and inputting to the other one of the two adjacent groups of sub-pixel columns source driving signals having a same polarity as source driving signals for the previous frame, wherein the liquid crystal display panel comprises a plurality of sub-pixels arranged in a matrix, each of the groups of sub-pixel columns comprising at least one column of sub-pixels; and during display time for an adjacent next frame, interchanging polarity inversion between the source driving signals input to the two adjacent groups of sub-pixel columns.

According to some embodiments, the source driving method further comprises: before the display time for the frame or after the display time for the adjacent next frame, inputting source driving signals having an opposite polarity to those for an adjacent previous frame to the sub-pixel columns during display time for a frame.

According to some embodiments, each of the groups of sub-pixel columns comprises only one column of sub-pixels.

According to some embodiments, during the display time for the frame, the inputting to one of two adjacent groups of sub-pixel columns source driving signals having an opposite polarity to source driving signals for a previous frame and the inputting to the other one of the two adjacent groups of sub-pixel columns source driving signals having a same polarity as source driving signals for the previous frame comprise: during the display time for the frame, inputting to odd columns of sub-pixels source driving signals having an opposite polarity to those for the previous frame, and inputting to even columns of sub-pixels source driving signals having a same polarity as those for the previous frame.

According to some embodiments, during the display time for the adjacent next frame, the interchanging polarity inversion between source driving signals input to the two adjacent groups of sub-pixel columns comprises: during the display time for the adjacent next frame, inputting to even columns of sub-pixels source driving signals having an opposite polarity to those for a previous frame, and inputting to odd columns of sub-pixels source driving signals having a same polarity as those for the previous frame.

According to some embodiments, during the display time for the frame, the inputting to one of two adjacent groups of sub-pixel columns source driving signals having an opposite polarity to source driving signals for a previous frame and the inputting to the other one of the two adjacent groups of sub-pixel columns source driving signals having a same polarity as source driving signals for the previous frame comprise: during the display time for the frame, inputting to even columns of sub-pixels source driving signals having an opposite polarity to those for the previous frame, and inputting to odd columns of sub-pixels source driving signals having a same polarity as those for the previous frame.

According to some embodiments, during the display time for the adjacent next frame, the interchanging polarity inversion between source driving signals input to the two adjacent groups of sub-pixel columns comprises: during the display time for the adjacent next frame, inputting to odd columns of sub-pixels source driving signals having an opposite polarity to those for a previous frame, and inputting to even columns of sub-pixels source driving signals having a same polarity as those for the previous frame.

According to some embodiments, the source driving method further comprises: determining whether inputting of source driving signals has been done to a last row of sub-pixels during display time for a current frame, if so, interchanging polarity inversion between the source driving signals input to two adjacent groups of sub-pixel columns; otherwise, maintaining the polarity inversion for the source driving signals input to the sub-pixel columns.

Another exemplary embodiment of the present disclosure provides a liquid crystal display panel driven by any of the source driving methods described above. The liquid crystal display panel comprises a plurality of sub-pixels, a plurality of gate lines and a plurality of data lines, wherein the sub-pixels are arranged in a matrix in intersection areas defined by the data lines and the gate lines.

According to some embodiments, in the liquid crystal display panel, the sub-pixels in each column of sub-pixels have a same color.

A further exemplary embodiment of the present disclosure provides a display device, comprising: any of the liquid crystal display panels described above, and a source driver chip configured to input the source driving signals to the data lines of the liquid crystal display panel.

### BRIEF DESCRIPTION OF THE DRAWINGS

FIG. 1 is a schematic view showing a conventional driving method for a liquid crystal display panel;

FIG. 2 is a schematic view showing a driving method for a liquid crystal display panel as provided by an embodiment of the present disclosure; and

FIG. 3 is a schematic view showing a driving method for a liquid crystal display panel as provided by another embodiment of the present disclosure.

### DETAILED DESCRIPTION

Implementations of the driving method for a liquid crystal display panel, the liquid crystal display panel and the display device provided by embodiments of the present disclosure will be described in detail below with reference to the accompanying drawings.

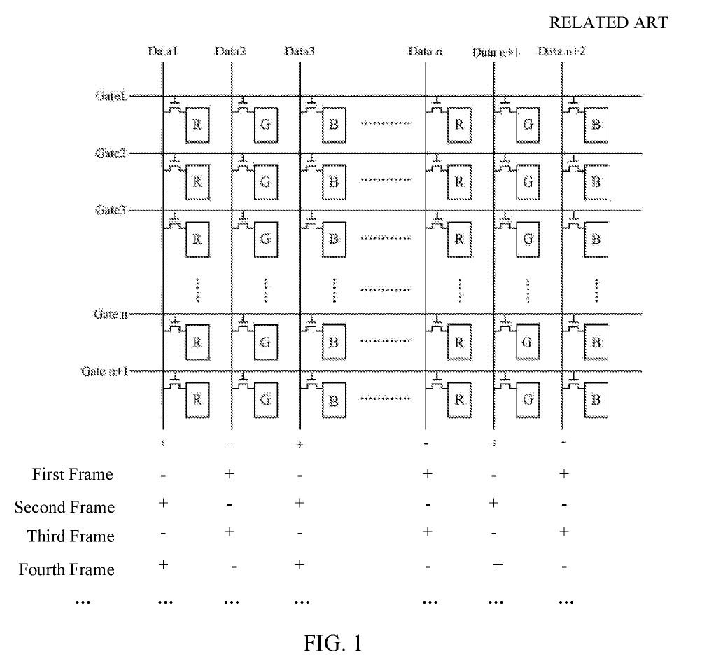

FIG. 1 illustrates a conventional source driving method for a liquid crystal display panel. As shown in FIG. 1, the source driving signals input by the data lines Datan to respective columns of sub-pixels are polarity inverted for each frame with respect to a previous frame, and frame-by-frame refreshing is carried out in cooperation with progressive scanning of the gate lines Gaten. In such a source driving method, since the polarity inversion is performed for each frame, the power consumption of the source driver chip is relatively high. The power consumption of the entire display product is thus relatively high due to the fact that the logic power consumption of a display product is mostly derived from the source driver chip.

In view of this, an embodiment of the present disclosure provides a source driving method for a liquid crystal display panel, including:

during display time for a frame, inputting to one of two adjacent groups of sub-pixel columns source driving signals having an opposite polarity to source driving signals for a previous frame, and inputting to the other one of the two adjacent groups of sub-pixel columns source driving signals having the same polarity as source driving signals for the previous frame, wherein the liquid crystal display panel includes a plurality of sub-pixels arranged in a matrix, and each of the groups of sub-pixel columns includes at least one column of sub-pixels; and

during display time for an adjacent next frame, interchanging polarity inversion between the source driving signals input to the two adjacent groups of sub-pixel columns.

As known to those skilled in the art, the liquid crystal display panel includes a plurality of gate lines and a plurality of data lines that intersect horizontally and vertically, and each of the intersections of the plurality of gate lines and the plurality of data lines defines a sub-pixel. In a typical RGB liquid crystal display panel, each pixel includes three sub-pixels, i.e., a red (R) sub-pixel, a green (G) sub-pixel, and a blue (B) sub-pixel. By controlling the display brightness of each sub-pixel separately, it is possible to control the display color and brightness of the pixel, and thereby control the displayed image of the entire display panel. Typically, in the liquid crystal display panel, the plurality of gate lines extend in a row direction of the sub-pixel matrix, and the plurality of data lines extend in a column direction of the sub-pixel matrix. Therefore, in the present disclosure, the direction in which the data lines extend is referred to as the column direction of the sub-pixels.

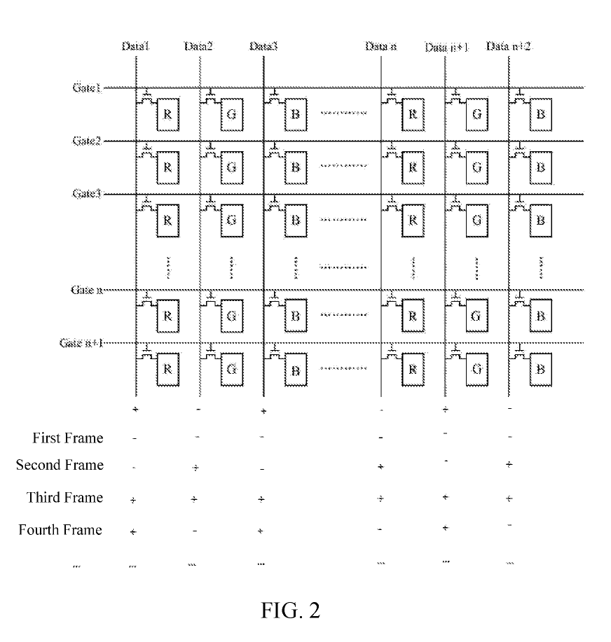

Specifically, as shown in FIG. 2, it is assumed that each group of sub-pixel columns includes one column of sub-pixels. The leftmost first group of sub-pixel columns (i.e., the first column of sub-pixels) and second group of sub-pixel columns (i.e., the second column of sub-pixels) shown in FIG. 2 are taken as an example. During display time for the first frame, a source driving signal having a negative polarity is input to the first column of sub-pixels, and a source driving signal having a negative polarity is also input to the second column of sub-pixels. During display time for the second frame, a source driving signal having the same polarity (i.e., negative polarity) as the source driving signal for the first frame is input to the first column of sub-pixels, and a source driving signal having an opposite polarity (i.e., positive polarity) to the source driving signal for the first frame is input to the second column of sub-pixels. During display time for the subsequent third frame, the polarity inversion is interchanged for the source driving signals input to the first column of sub-pixels and the second column of sub-pixels. That is, during the display time for the third frame, a source driving signal having an opposite polarity (i.e., positive polarity) to the source driving signal for the second frame is input to the first column of sub-pixels, and a source driving signal having the same polarity (i.e., positive polarity) as the source driving signal for the second frame is input to the second column of sub-pixels. Similarly, during display time for the fourth frame, a source driving signal having the same polarity (i.e., positive polarity) as the source driving signal for the third frame is input to the first column of sub-pixels, and a source driving signal having an opposite polarity (i.e., negative polarity) to the source driving signal for the third frame is input to the second column of sub-pixels. The situation is similar for adjacent second group of sub-pixel columns (i.e., the second column of sub-pixels) and third group of sub-pixel columns (i.e., the third column of sub-pixels). It is to be noted that although in FIG. 2 each of the groups of sub-pixel columns includes only one column of sub-pixels, this is merely an example, and that the present disclosure is not so limited. In other embodiments, each of the groups of sub-pixel columns may include two or more columns of sub-pixels.

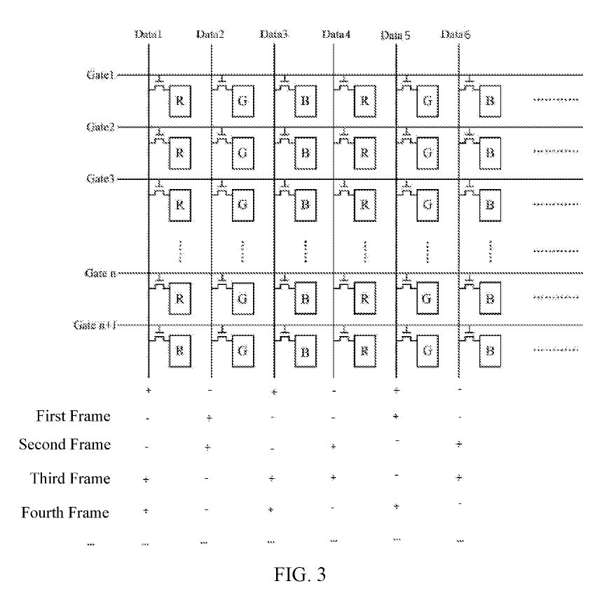

FIG. 3 illustrates a source driving method for a liquid crystal display panel according to another embodiment of the present disclosure. As shown in FIG. 3, it is assumed that each of the groups of sub-pixel columns includes three columns of sub-pixels. From left to right, the first group of sub-pixel columns includes first to third columns of sub-pixels, and the second group of sub-pixel columns includes fourth to sixth columns of sub-pixels. During display time for the first frame, source driving signals having a negative polarity, a positive polarity and a negative polarity are respectively input to the three columns of sub-pixels in the first group of sub-pixel columns, and source driving signals having a negative polarity, a positive polarity and a negative polarity are respectively input to the three columns in the second group of sub-pixel columns. During display time for the second frame, source driving signals having the same polarity (i.e., negative, positive and negative, respectively) same as those for the first frame are input to the first group of sub-pixel columns, and source driving signals having an opposite polarity (i.e., positive, negative and positive, respectively) to those for the first frame are input to the second groups of sub-pixel columns. During display time for the subsequent third frame, the polarity inversion is interchanged between the source driving signals input to the first group of sub-pixel columns and the second group of sub-pixel columns. That is, during the display time for the third frame, source driving signals having an opposite polarity (i.e., positive, negative and positive, respectively) to those for the second frame are input to the first group of sub-pixel columns, and source driving signals having the same polarity (i.e., positive, negative and positive, respectively) as those for the second frame are input to the second groups of sub-pixel columns. Similarly, during display time for the fourth frame, source driving signals having the same polarity (i.e., positive, negative and positive, respectively) as those for the third frame are input to the first group of sub-pixel columns, and source driving signals having an opposite polarity (i.e., negative, positive and negative, respectively) to those for the third frame are input to the second groups of sub-pixel columns. The situation is similar for adjacent second group of sub-pixel columns and third group of sub-pixel columns (not shown).

It is to be noted that although the principle of the present disclosure is illustrated in FIGS. 2 and 3 based on an example of an RGB liquid crystal display panel, the present disclosure is not so limited. In other embodiments, the liquid crystal display panel may be a liquid crystal display panel using other color schemes, for example, an RGBW liquid crystal display panel or the like.

In the above source driving method provided by an embodiment of the present disclosure, only the source driving signals input to one of two adjacent groups of sub-pixel columns are polarity inverted for each frame with respect to a previous frame, while source driving signals having the same polarity as those for the previous frame are input to the other group of sub-pixel columns. During display time for an adjacent next frame, the polarity inversion is interchanged between the source driving signals input to the two adjacent groups of sub-pixel columns. In this way, the polarity-inverted sub-pixel columns cause corresponding liquid crystal molecules to be reversed, and the sub-pixel columns to which the source driving signals having the same polarity as those for the previous frame are input maintain the rotation angle of corresponding liquid crystal molecules. In contrast to the source driving method as shown in FIG. 1 in which the source driving signals input to respective sub-pixel columns are polarity inverted during the display time for each frame, polarity inversion is only performed for the source driving signals input to part of the sub-pixel columns in each frame in the driving method for a liquid crystal display panel provided by an embodiment of the present disclosure. As a result, the power consumption can be reduced.

In certain exemplary embodiments, the source driving method provided by an embodiment of the present disclosure may further comprise: inputting to the sub-pixel columns source driving signals having an opposite polarity to those for an adjacent previous frame, in a frame before the frame in which the source driving signals having an opposite polarity to those for a previous frame are input to one of two adjacent groups of sub-pixel columns and the source driving signals having the same polarity as those for the previous frame are input to the other one of the two adjacent groups of sub-pixel columns, or in a frame after the frame in which the polarity inversion is interchanged between the source driving signals input to the two adjacent groups of sub-pixel columns. That is, during the process of driving the display panel to display multiple frames of images by the source driving method provided by an embodiment of the present disclosure, the polarity inversion scheme for part of the sub-pixel columns as provided by embodiments of the present disclosure may be applied continuously to all consecutive two frames, or the polarity inversion scheme for part of the sub-pixel columns provided by embodiments of the present disclosure may also be applied alternatingly at least every other frame, and the source driving signals input to all the sub-pixel columns may be polarity inverted with the conventional source driving method as shown in FIG. 1 during the display time for the at least one alternate-frame, which can on the one hand ensure normal driving of the display panel, and on the other hand reduce the power consumption because of applying the polarity inversion scheme for part of the sub-pixel columns in alternate frames.

In certain exemplary embodiments, in the above source driving method provided by an embodiment of the present disclosure, each of the groups of sub-pixel columns may include only one column of sub-pixels. As shown in FIG. 2, during the display time for a frame, source driving signals having an opposite polarity to those for the previous frame may be input to odd columns of sub-pixels, and source driving signals having the same polarity as those for the previous frame may be input to even columns of sub-pixels. During the display time for an adjacent next frame, source driving signals having an opposite polarity to those for the previous frame are input to even columns of sub-pixels, and source driving signals having the same polarity as those for the previous frame are input to odd columns of sub-pixels. In this way, during the display time for each frame, the polarity-inverted sub-pixel columns control corresponding liquid crystal molecules to be reversed, and the sub-pixel columns to which source driving signals having the same polarity as those for the previous frame are input maintain the rotation angle of corresponding liquid crystal molecules. In contrast to the source driving method as shown in FIG. 1 in which the source driving signals input to respective sub-pixel columns are polarity inverted during the display time for each frame, polarity inversion is only performed for the source driving signals input to part of the sub-pixel columns in each frame in the driving method for a liquid crystal display panel provided by an embodiment of the present disclosure. As a result, the power consumption can be reduced.

Alternatively, in the above source driving method provided by an embodiment of the present disclosure, each of the groups of sub-pixel columns may include only one column of sub-pixels. During the display time for a frame, source driving signals having an opposite polarity to those for the previous frame may be input to even columns of sub-pixels, and source driving signals having the same polarity as those for the previous frame may be input to odd columns of sub-pixels. During the display time for an adjacent next frame, source driving signals having an opposite polarity to those for the previous frame are input to odd columns of sub-pixels, and source driving signals having the same polarity as those for the previous frame are input to even columns of sub-pixels. In this way, during the display time for each frame, the polarity-inverted sub-pixel columns control corresponding liquid crystal molecules to be reversed, and the sub-pixel columns to which source driving signals having the same polarity as those for the previous frame are input maintain the rotation angle of corresponding liquid crystal molecules. In contrast to the source driving method as shown in FIG. 1 in which polarity inversion is performed for the source driving signals input to respective sub-pixel columns during the display time for each frame, the polarities of the source driving signals input to the sub-pixel columns are controlled alternately in each frame in the driving method for a liquid crystal display panel provided by an embodiment of the present disclosure, so that polarity inversion is always performed only for the source driving signals input to half of the sub-pixel columns, which can thus achieve the purpose of reducing the power consumption.

In certain exemplary embodiments, the source driving method provided by an embodiment of the present disclosure may further comprise: determining whether inputting of source driving signals has been done to the last row of sub-pixels during the display time for a current frame, if so, interchanging the polarity inversion between the source driving signals input to two adjacent groups of sub-pixel columns; otherwise, maintaining the polarity inversion for the source driving signals input to the sub-pixel columns. Specifically, in the source driving method provided by an embodiment of the present disclosure, after inputting the source driving signals to the sub-pixel columns in each frame, it may be first determined whether the inputting of the source driving signals has been done to the last row of sub-pixels, if so, the polarity inversion is interchanged between the source driving signals input to two adjacent groups of sub-pixel columns; otherwise, the polarity inversion is maintained for the source driving signals input to the sub-pixel columns, thereby ensuring that the inputting of the source driving signals is done to all of the sub-pixel columns to ensure normal display of the display panel.

An embodiment of the present disclosure further provides a liquid crystal display panel driven by the source driving method provided above by an embodiment of the present disclosure, which includes: a plurality of sub-pixels arranged in a matrix, and the sub-pixels in each column of sub-pixels have the same color. For example, as shown in FIG. 2, the liquid crystal display panel includes a plurality of gate lines Gaten and a plurality of data lines Datan, and the sub-pixels are arranged in a matrix in intersection areas defined by the data lines and the gate lines. A gate scan signal is input to the gate lines sequentially to turn on respective rows of sub-pixels one by one, and corresponding source driving signals are input by respective data lines to respective turned-on sub-pixels to realize frame-by-frame refreshing, thereby achieving normal display of the display panel.

An embodiment of the present disclosure further provides a display device including the liquid crystal display panel described above, and a source driver chip configured to input the source driving signals to the data lines of the liquid crystal display panel. The display device may be applied to any product or component having a display function, such as a mobile phone, a tablet computer, a television, a display, a notebook computer, a digital photo frame, a navigator, and the like. Since the principle of the display device in solving problems is similar to that of the liquid crystal display panel, the implementation of the display device may be derived with reference to the implementation of the liquid crystal display panel described above, repeated description of which is thus omitted.

Embodiments of the present disclosure provide a source driving method for a liquid crystal display panel, a liquid crystal display panel, and a display device. The source driving method includes, during display time for a frame, inputting to one of two adjacent groups of sub-pixel columns source driving signals having an opposite polarity to source driving signals for a previous frame, and inputting to the other one of the two adjacent groups of sub-pixel columns source driving signals having the same polarity as source driving signals for the previous frame. The liquid crystal display panel includes a plurality of sub-pixels arranged in a matrix, and each of the groups of sub-pixel columns includes at least one column of sub-pixels. The source driving method further comprises interchanging polarity inversion between the source driving signals input to the two adjacent groups of sub-pixel columns during the adjacent next-frame display time. In this way, only the source driving signals input to one of two adjacent groups of sub-pixel columns are polarity inverted for each frame with respect to a previous frame, while source driving signals having the same polarity as those for the previous frame are input to the other group of sub-pixel columns. During the adjacent next-frame display time, the polarity inversion is interchanged between the source driving signals input to the two adjacent groups of sub-pixel columns. In this way, the polarity-inverted sub-pixel columns cause corresponding liquid crystal molecules to be reversed, and the sub-pixel columns to which source driving signals having the same polarity as those for the previous frame are input maintain the rotation angle of corresponding liquid crystal molecules. In contrast to the source driving method as shown in FIG. 1 in which the source driving signals input to respective sub-pixel columns are polarity inverted during the display time for each frame, polarity inversion is only performed for the source driving signals input to part of the sub-pixel columns in each frame in the driving method for a liquid crystal display panel provided by an embodiment of the present disclosure. As a result, the power consumption can be reduced.

It is apparent for those skilled in the art to make various modifications and variations to the present disclosure without departing from the spirit and scope thereof. Thus, if these modifications and variations to the present disclosure pertain to the scope of the claims of the present disclosure and equivalent technologies thereof, these modifications and variations are intended to be encompassed in the present disclosure.

1. A source driving method for a liquid crystal display panel, comprising:
during a display time for a frame, inputting to one of two adjacent groups of sub-pixel columns source driving signals having an opposite polarity to a plurality of source driving signals for a previous frame, and inputting to the other one of the two adjacent groups of sub-pixel columns a plurality of source driving signals having a same polarity as the source driving signals for the previous frame, wherein the liquid crystal display panel comprises a plurality of sub-pixels arranged in a matrix, each of the groups of sub-pixel columns comprising at least one column of sub-pixels; and
during the display time for an adjacent next frame, interchanging polarity inversion between the input of the source driving signals to the two adjacent groups of sub-pixel columns.

2. The source driving method according to claim 1, further comprising:
before the display time for the frame or after the display time for the adjacent next frame, inputting the source driving signals having an opposite polarity to those for an adjacent previous frame to the sub-pixel columns during the display time for the frame.

3. The source driving method according to claim 1, wherein each of the groups of sub-pixel columns comprises only one column of sub-pixels.

4. The source driving method according to claim 3, wherein during the display time for the frame, the inputting to one of two adjacent groups of sub-pixel columns the source driving signals having an opposite polarity to the source driving signals for a previous frame and the inputting to the other one of the two adjacent groups of sub-pixel columns the source driving signals having a same polarity as source driving signals for the previous frame comprise:
during the display time for the frame, inputting to odd columns of sub-pixels the source driving signals having an opposite polarity to those for the previous frame, and inputting to even columns of sub-pixels the source driving signals having a same polarity as those for the previous frame.

5. The source driving method according to claim 4, wherein during the display time for the adjacent next frame, the interchanging polarity inversion between source driving signals input to the two adjacent groups of sub-pixel columns comprises:
during the display time for the adjacent next frame, inputting to even columns of the sub-pixels source driving signals having an opposite polarity to those for a previous frame, and inputting to odd columns of the sub-pixels source driving signals having a same polarity as those for the previous frame.

6. The source driving method according to claim 3, wherein during the display time for the frame, the inputting to one of two adjacent groups of sub-pixel columns the source driving signals having an opposite polarity to the source driving signals for a previous frame and the inputting to the other one of the two adjacent groups of sub-pixel columns source the driving signals having a same polarity as the source driving signals for the previous frame comprise:
during the display time for the frame, inputting to even columns of sub-pixels the source driving signals having an opposite polarity to those for the previous frame, and inputting to odd columns of sub-pixels the source driving signals having a same polarity as those for the previous frame.

7. The source driving method according to claim 6, wherein during the display time for the adjacent next frame, the interchanging polarity inversion between the source driving signals input to the two adjacent groups of sub-pixel columns comprises:
during the display time for the adjacent next frame, inputting to odd columns of sub-pixels the source driving signals having an opposite polarity to those for a previous frame, and inputting to even columns of sub-pixels the source driving signals having a same polarity as those for the previous frame.

8. The source driving method according to claim 1, further comprising:
determining whether inputting of the source driving signals has been done to a last row of sub-pixels the during display time for a current frame, if so, interchanging polarity inversion between the source driving signals input to two adjacent groups of sub-pixel columns; otherwise, maintaining the polarity inversion for the source driving signals input to the sub-pixel columns.

9. A liquid crystal display panel driven by the source driving method according to claim 1, comprising: a plurality of sub-pixels, a plurality of gate lines and a plurality of data lines, wherein the sub-pixels are arranged in a matrix in intersection areas defined by the data lines and the gate lines.

10. The liquid crystal display panel according to claim 9, wherein the sub-pixels in each sub-pixel column sub-pixels have a same color.

11. A display device, comprising: the liquid crystal display panel according to claim 9, and a source driver chip configured to input the source driving signals to the data lines of the liquid crystal display panel.

12. The source driving method according to claim 2, wherein each of the groups of sub-pixel columns comprises only one column of sub-pixels.

13. A liquid crystal display panel driven by the source driving method according to claim 2, comprising: a plurality of sub-pixels, a plurality of gate lines and a plurality of data lines, wherein the sub-pixels are arranged in a matrix in intersection areas defined by the plurality of data lines and the gate lines.

14. A liquid crystal display panel driven by the source driving method according to claim 3, comprising: a plurality of sub-pixels, a plurality of gate lines and a plurality of data lines, wherein the sub-pixels are arranged in a matrix in intersection areas defined by the data lines and the gate lines.

15. A liquid crystal display panel driven by the source driving method according to claim 4, comprising: a plurality of sub-pixels, a plurality of gate lines and a plurality of data lines, wherein the sub-pixels are arranged in a matrix in intersection areas defined by the data lines and the gate lines.

16. A liquid crystal display panel driven by the source driving method according to claim 5, comprising: a plurality of sub-pixels, a plurality of gate lines and a plurality of data lines, wherein the sub-pixels are arranged in a matrix in intersection areas defined by the data lines and the gate lines.

17. A liquid crystal display panel driven by the source driving method according to claim 6, comprising: a plurality of sub-pixels, a plurality of gate lines and a plurality of data lines, wherein the sub-pixels are arranged in a matrix in intersection areas defined by the data lines and the gate lines.

18. A liquid crystal display panel driven by the source driving method according to claim 7, comprising: a plurality of sub-pixels, a plurality of gate lines and a plurality of data lines, wherein the sub-pixels are arranged in a matrix in intersection areas defined by the data lines and the gate lines.

19. A liquid crystal display panel driven by the source driving method according to claim 8, comprising: a plurality of sub-pixels, a plurality of gate lines and a plurality of data lines, wherein the sub-pixels are arranged in a matrix in intersection areas defined by the data lines and the gate lines.

20. A display device, comprising: the liquid crystal display panel according to claim 10, and a source driver chip configured to input the source driving signals to the data lines of the liquid crystal display panel.
